(19) United States
(12) Patent Application Publication
(10) Pub. No.: US 2026/0115730 A1
(43) Pub. Date: Apr. 30, 2026

(54) SYSTEM FOR FIXING WEAR PLATES TO A CRUSHER JAW OF A COMPACT ECCENTRIC CRUSHER

(71) Applicant: METSO USA INC., Brookfield, WI (US)

(72) Inventors: Guido Leuschen, Bielefeld (DE); Leon Bei der Sandwisch, Neuenkirchen (DE)

(73) Assignee: METSO USA INC., Brookfield, WI (US)

(21) Appl. No.: 18/932,866

(22) Filed: Oct. 31, 2024

(51) Int. Cl. B02C 1/10; B02C 1/08

(52) U.S. Cl. CPC B02C 1/10; B02C 1/08; B02C 2210/02

(57) ABSTRACT

A compact eccentric crusher having a crusher jaw that includes a series of wear plates mounted to a frame. The frame of the crusher jaw includes a support surface that provide a mounting location for the wear plates. The wear plates are identical members mounted in an end-to-end orientation and retained on the support surface of the crusher jaw frame. An end stop is located at a second end of the frame and engages the lower wear plate. A master wedge is mounted at the first end of the frame and engages the upper wear plate. An auxiliary wedge is positioned between the wear plates and is secured to the frame to support the wear plates during operation of the compact eccentric crusher. The wear plates can be released and removed from the frame upon wear by removing the master wedge and lifting the wear plates from the frame.

### BACKGROUND

The present disclosure generally relates to a crusher jaw and a compact eccentric crusher incorporating the crusher jaw of the present disclosure. More specifically, the present disclosure relates to a crusher jaw that includes a series of wear plates mounted in an end-to-end configuration on the frame of the crusher jaw and held in place by a series of wedge elements.

Presently, different types of crushers are being used to reduce the size of mineral material present in an infeed to the crusher. After processing, the size of the mineral material has been reduced to create a supply of the mineral material having smaller sized individual components. In these types of crushers, a moving crushing member moves toward and away from a stationary crushing member to create a varying crushing gap to crush the mineral material of the infeed.

One type of crusher used to reduce the size of mineral material is referred to as a compact eccentric crusher. In a compact eccentric crusher, a freely rotatable crushing roller is mounted to an eccentric shaft by a series of roller bearings. The crushing roller is spaced from a generally stationary crusher jaw. In the compact eccentric crusher, the eccentric arrangement of the crushing roller on the eccentric drive shaft creates eccentric movement of the crushing roller toward and away from the stationary crusher jaw. This movement varies the size of the crushing gap, which causes the mineral material fed into the compact eccentric crusher to be crushed in the crushing gap.

During operation, mineral material being crushed come into contact with a wear surface formed on the stationary crusher jaw. The wear surface is typically formed by a series of wear elements that are secured to a frame of the crusher jaw. After a period of use, the series of wear elements become significantly worn and must be removed and replaced. Since the interior of the compact eccentric crusher is difficult to access, it is desirable to be able to move the crusher jaw to a maintenance position and remove the worn wear elements from the crusher jaw frame. After the worn wear elements are removed, new or refurbished wear elements are installed on the crusher jaw frame. Presently, the removal of the wear elements from the frame of the stationary crusher jaw requires the removal of a significant amount of the crusher assembly, making maintenance both time consuming and labor intensive.

The inventors of the present disclosure have recognized a need for an improvement in the ability to remove wear elements from the frame of the crusher jaw when the crusher jaw is in a maintenance position. The improvement of the present disclosure utilizes wedge members between the wear elements and a master wedge that holds the wear elements in an end-to-end use condition.

### SUMMARY

The present disclosure generally relates to a crusher jaw of a compact eccentric crusher. More specifically, the present disclosure relates to a crusher jaw that includes a series of wear plate mounted in an end-to-end configuration and fixed to the frame of the crusher jaw by a series of wedge elements.

In accordance with one exemplary embodiment of the present disclosure, a crusher is provided that is operable to crush a supply of mineral material. The crusher includes a crusher frame having a pair of side walls that at least partially define a crushing chamber that receives the supply of mineral material being crushed. A crusher jaw is positioned to at least partially define the crushing chamber along with the side walls. The crusher further includes a crushing roller that is spaced from the stationary crusher jaw member to define a crushing gap. During operation, the crushing roller is movable toward and away from the stationary crushing member to change the crushing gap and crush mineral material in the crushing gap.

The crusher jaw that is included as part of the crusher includes a frame that has a support surface extending from a first end to a second end. The support surface of the frame is configured to removably support a plurality of wear plates in an end-to-end arrangement such that the combination of the wear plates define a wear surface for the crusher jaw.

In one exemplary embodiment, each of the wear plates are identical to each other and extend between a first end surface and a second end surface. The first and second end surfaces of each wear plate includes a retaining groove that is recessed from the respective end surface. When the wear plates are supported on the frame, an auxiliary wedge is mounted to the frame between the adjacent wear plates. Each of the auxiliary wedges are configured to be received in receiving slots formed between the adjacent wear plates by the combination of the retaining grooves on the end surfaces of the wear plates.

In another exemplary embodiment, the frame includes an end stop on the second end of the frame. The end stop includes a retaining finger configured to be received in the retaining groove on the wear plate positioned nearest the second end of the frame. The interaction between the retaining finger on the end stop and the lowermost wear plate restricts the movement of the wear plate past the second end of the frame. A master wedge is included as part of the frame assembly and is positioned at the first end of the frame. The master wedge is located to contact one of the ends of the uppermost wear plate. The master wedge secures the combination of the wear plates in connection with the end stop.

In accordance with one exemplary embodiment, the support surface of the frame includes a series of spaced flat mounting surfaces that are each configured to receive and support one of the wear plates. Each of the wear plates are constructed to include a curved wear surface and a flat engagement surface. The flat engagement surface on the wear plate is positioned in contact with one of the flat mounting surfaces to support the wear plate. In one contemplated embodiment, each of the flat mounting surfaces on the frame includes a finger that is received in a recess formed in the flat engagement surface on the wear plate to restrict the axial movement of the wear plate.

In accordance with another contemplated embodiment, a crusher jaw is provided for use with a compact eccentric crusher that includes a crushing roller movable toward and away from the crusher jaw along an eccentric movement path to crush mineral material during operation. The crusher jaw includes a frame that has a support surface that extends from a first end to a second end. The support surface of the frame is configured to removably support a plurality of wear plates in an end-to-end arrangement such that the combination of the wear plates define a wear surface for the crusher jaw.

In one exemplary embodiment of the crusher jaw, each of the wear plates are identical to each other and extend between a first end surface and a second end surface. The first and second end surfaces of each wear plate includes a retaining groove that is recessed from the respective end surface. When the wear plates are supported on the frame, an auxiliary wedge is mounted to the frame between the adjacent wear plates. Each of the auxiliary wedges are configured to be received in a receiving slot formed between the adjacent wear plates by the combination of the retaining grooves on the end surfaces of the adjacent wear plates.

In another exemplary embodiment of the crusher jaw, the frame includes an end stop on the second end of the frame. The end stop includes a retaining finger configured to be received in the retaining groove on the wear plate positioned nearest the second end of the frame. The interaction between the retaining finger on the end stop and the lowermost wear plate restricts the movement of the wear plate past the second end of the frame. A master wedge is included as part of the frame assembly and is positioned at the first end of the frame and located to contact one of the ends of the uppermost wear plate. The master wedge secures the combination of the wear plates in connection with the end stop.

In accordance with one exemplary embodiment of the crusher jaw, the support surface of the frame includes a series of spaced flat mounting surfaces that are each configured to receive and support one of the wear plates. Each of the wear plates are constructed to include a curved wear surface and a flat engagement surface. The flat engagement surface on the wear plate is positioned in contact with one of the flat mounting surfaces to support the wear plate. In one contemplated embodiment, each of the flat mounting surfaces includes a finger that is received in the flat engagement surface on the wear plate to restrict the axial movement of the wear plate.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a side view showing the general operation of a compact eccentric crusher that includes a stationary crusher jaw and a movable crushing roller;

FIG. 2 is a perspective view of a compact eccentric crusher including the subject matter of the present disclosure;

FIG. 3 is a bottom perspective view of the compact eccentric crusher including the crusher jaw of the present disclosure;

FIG. 4 is a section view of the compact eccentric crusher showing the crusher jaw and crushing roller;

FIG. 5 is a front perspective view of the crusher jaw with the series of aligned wear plates installed in accordance with the present disclosure;

FIG. 6 is a rear perspective view of the crusher jaw with the series of wear plates installed;

FIG. 7 is an exploded view showing the components for mounting and securing the series of wear plates on the crusher jaw; and

FIG. 8 is a section view of the crusher jaw showing the mounting of the series of wear plates.

### DETAILED DESCRIPTION

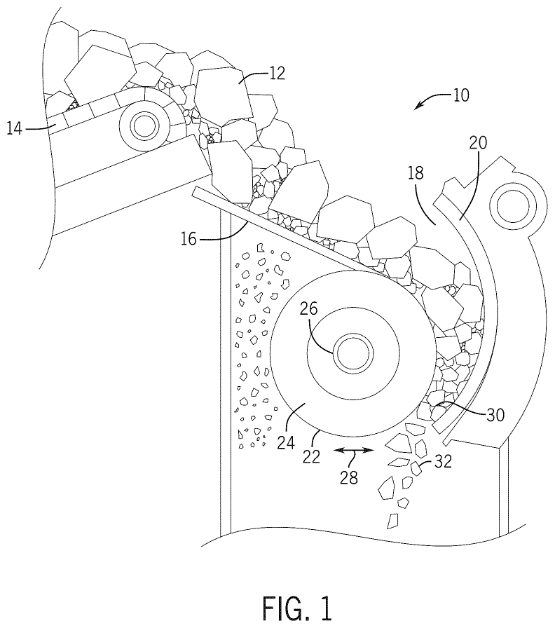

FIG. 1 generally illustrates the operation of a compact eccentric crusher 10. The compact eccentric crusher 10 shown in FIG. 1 is a representative embodiment that is included to show the general operation and configuration of a compact eccentric crusher 10 and does not limit the scope of the present disclosure since it is being included for illustrative purposes. As illustrated in FIG. 1, the compact eccentric crusher 10 receives a supply of mineral material 12 from an infeed conveyor 14. In the embodiment shown, the supply of mineral material 12 may include particles of different sizes that all fall upon an infeed screen 16 that includes slots or other openings that allow particles of a small enough size to bypass the primary crushing operation. The infeed screen 16 directs the larger particles of the supply of mineral material into a crushing chamber 18. In other contemplated embodiments, the infeed screen 16 could be eliminated such that the entire supply of material would be directed to the crushing chamber 18.

The crushing chamber 18 is generally formed between the crusher jaw 20 and the outer surface 22 of the crushing roller 24. The crushing roller 24 is mounted to a drive shaft 26 that is supported by an eccentric bearing assembly that creates eccentric movement of the outer surface 22 of the crushing roller 24 along an eccentric path that includes movement toward and away from the stationary crusher jaw 20, as schematically illustrated by arrow 28. The eccentric movement of the entire crushing roller 24 toward and away from the stationary crusher jaw 20 increases and decreases the size of the crushing gap 30. During operation of the crushing roller 24, the increase and decrease in the size of the crushing gap 30 crushes the larger particles of the infeed stream to result in an outlet product flow 32.

In addition to the movement of the entire crushing roller 24, the position of the crusher jaw 20 can be modified to vary the maximum and minimum size of the crushing gap 30 through movement of the support arm 34. However, during the crushing operation, it is the eccentric movement of the crushing roller 24 relative to the stationary crusher jaw 20 that creates the crushing forces to convert the inlet product flow to the outlet product flow 32.

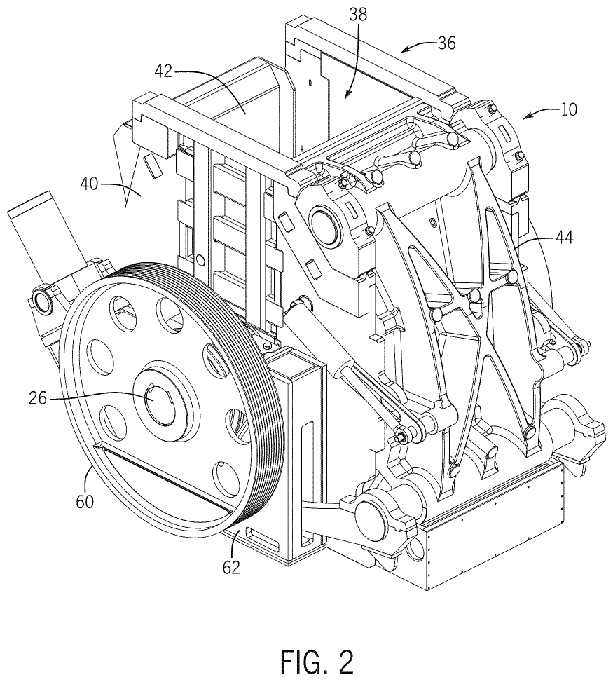

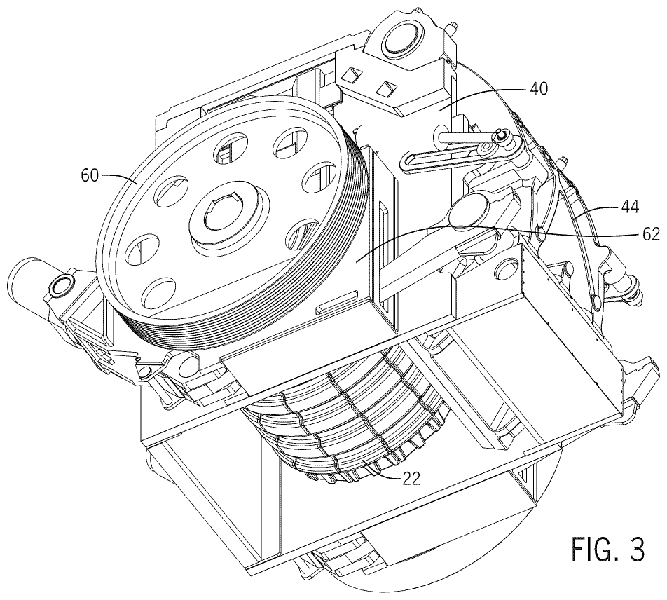

Referring now to FIGS. 2 and 3, the compact eccentric crusher 10 constructed in accordance with the present disclosure will now be further described. In the embodiment shown in FIGS. 2 and 3, the compact eccentric crusher 10 is shown as including a frame 36 that is designed to support the eccentric movement of the crusher roller and to receive a product flow at an open upper end 38 that feeds into an internal crushing chamber 18, as was schematically illustrated in FIG. 1. The frame 36 includes a pair of side walls 40 that are each spaced from each other to define a portion of the crushing chamber. A rear wall 42 further defines the crushing chamber while the crusher jaw assembly 44 defines the front portion of the crushing chamber.

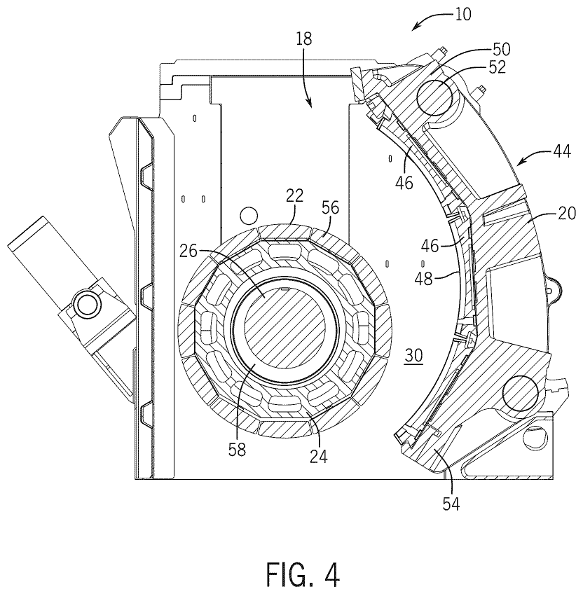

The crusher jaw assembly 44 includes the crusher jaw 20 that includes a series of wear plates 46 as best shown in FIG. 4. The wear plates 46 define a contact surface 48 for the crusher jaw 20 that is spaced from the outer surface 22 of the crushing roller 24. The spacing between the outer surface 22 of the crushing roller 24 and the contact surface 48 of the wear plates 46 creates the crushing gap 30 used to crush the mineral material fed into crushing chamber 18 of the compact eccentric crusher 10. In the embodiment shown in FIG. 4, an upper end 50 of the crushing jaw 20 is mounted for rotational movement about a pivot point 52. The lower end 54 of the crusher jaw 20 can be moved inward and outward to adjust the size of the crushing gap 30. As indicated previously, during operation of the compact eccentric crusher 10, the crusher jaw 20 is maintained in a stationary position while the crushing roller 24 moves along an eccentric path to increase and decrease the size of the crushing gap 30 to crush the mineral material. In addition, the crusher jaw 20 is able to shift outward to react to an overload condition in the crushing chamber 18, such as when tramp material enters into the crushing gap 30 and cannot be crushed.

The crushing roller 24 includes a series of wear members 56 installed on the crushing roller 24 to define the outer surface 22. During operation of the compact eccentric crusher 10, the outer surface 22 contacts the mineral material being crushed and is thus subject to wear. The individual wear members 56 can be removed from the crushing roller 24 upon sufficient wear. The crushing roller 24 is mounted to the drive shaft 26 by a series of roller bearings such that the crushing roller 24 can freely rotate relative to the drive shaft 26. During normal operation, the crushing roller 24 may not rotate or may rotate in the opposite direct as the rotation of the drive shaft 26. The drive shaft 26 is rotatable by a drive motor or motors during operation of the compact eccentric crusher 10.

As illustrated in the section view of FIG. 4, an eccentric bearing 58 is located between the crushing roller 24 and the drive shaft 26. In this manner, rotation of the drive shaft 26 creates eccentric movement of the entire crushing roller 24, thus causing the lateral movement of the crushing roller 24 toward and away from the crusher jaw 20. Such eccentric movement increases and decreases the size of the crushing gap 30 to crush the mineral material in the crushing gap 30.

Referring back to FIGS. 2 and 3, the compact eccentric crusher 10 further includes a fly wheel 60 mounted to either side of the drive shaft 26. The fly wheel 60 provides rotational mass that combines with the mass of the crushing roller during operation of the compact eccentric crusher 10. The fly wheels 60 are mounted axially outward from a bearing support structure 62 located on each side of the compact eccentric crusher 10. The bearing support structures 62 provide support for one of a pair of bearing assemblies that are used to support the crushing roller within the open crushing chamber 18 defined by the frame.

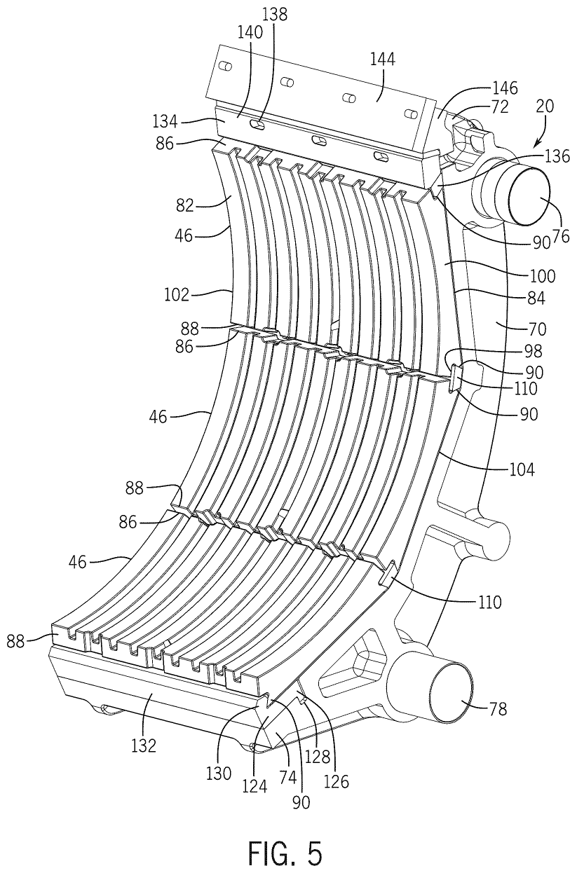

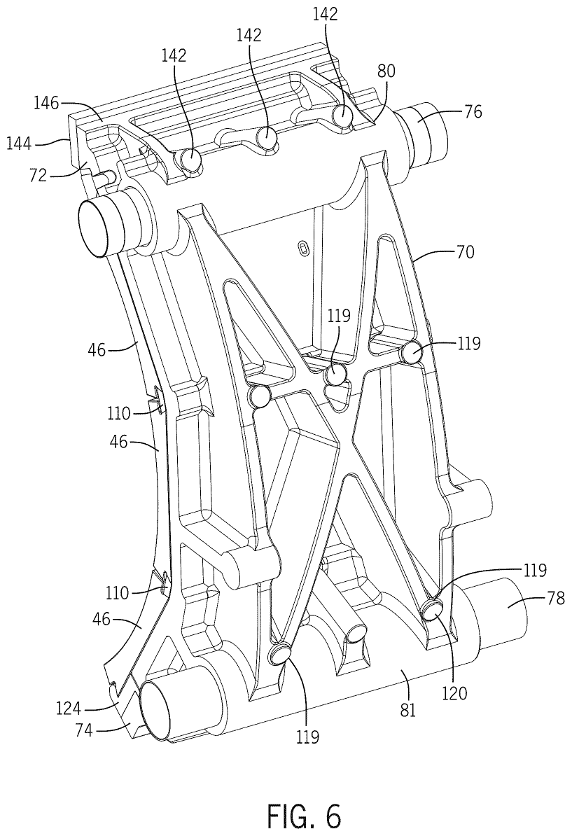

FIG. 5 illustrates the crusher jaw 20 as removed from the entire compact eccentric crusher that was shown in FIGS. 2-4. The crusher jaw 20 generally includes a frame 70 that extends from a first end 72 to a second end 74. The frame 70 is supported for pivotal movement about both an upper pivot shaft 76 and a lower pivot shaft 78. Pivoting movement about the upper pivot shaft 76 is used to adjust the size of the crushing gap between the crusher jaw 20 and the crushing roller while pivoting movement about the lower pivot shaft 78 allows the entire crusher jaw 20 to pivot outward into a maintenance position. As shown in the back view of FIG. 6, both the upper pivot shaft 76 and the lower pivot shaft 78 are received within a barrel portion 80, 81 located at the respective first end 72 and second end 74 of the frame 70.

Referring back to FIG. 5, the frame 70 is designed to support a series of wear plates 46. Each of the wear plates 46 are formed from a durable material and in the embodiment illustrated, three wear plates 46 are positioned in an end-to-end orientation. Each of the wear plates 46 shown in FIG. 5 is an identical component such that the location of each of the individual wear plates 46 can be interchanged and only one type of wear plate 46 is required for the crusher jaw 20 shown. Further, the wear plates 46 have identical ends and thus can be rotated and used in either direction. As can be understood in FIG. 5, each of the wear plates 46 includes a curved, outer wear surface 82 and a generally flat back engagement surface 84. The flat engagement surface 84 is designed and configured to be received upon the frame 70 such that the frame 70 can support the series of wear plates 46 in the operative position shown in FIG. 5.

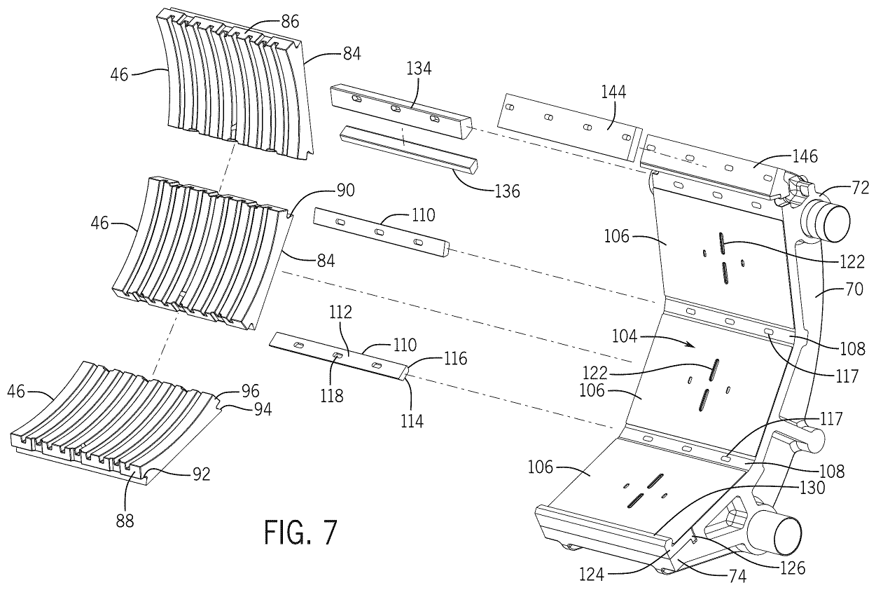

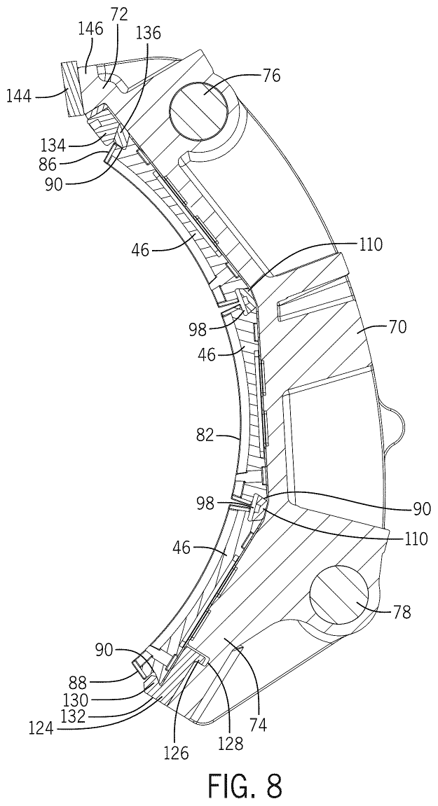

Referring now to FIGS. 5 and 7, each of the wear plates 46 extends between a first end surface 86 and a second end surface 88. The first and second end surfaces 86, 88 are identical to each other such that the orientation of the wear plate 46 could be reversed and each of the wear plates 46 could be positioned in any one of the three locations shown in FIGS. 5 and 7. Both the first and second end surfaces 86, 88 of the individual wear plates 46 include a retaining groove 90 that is recessed from the otherwise planar first or second end surface 86, 88. Each of the retaining grooves 90 includes an internal shoulder 92 that transitions between an inner wall 94 and a top wall 96. As is also shown in FIG. 8, when a pair of the wear plates 46 are oriented in an end-to-end configuration, the retaining grooves 90 at mating ends of two adjacent wear plates 46 define a receiving slot 98 that extends across the width of a pair of mating wear plates 46 from the first side edge 100 to the second side edge 102.

Referring back to FIG. 7, the frame 70 defines a support surface 104 that is designed to receive and support the series of individual wear plates 46 in and end-to-end configuration. The support surface 104 shown in FIG. 7 includes three generally flat mounting surfaces 106 that combine to extend from the first end 72 to the second end 74. Each of the generally flat mounting surfaces 106 are designed to provide a point of support and attachment for the individual flat engagement surface 84 formed on each of the wear plates 46.

In the embodiment shown in FIG. 7, the upper mounting surface 106 is separated from the middle mounting surface 106 by a wedge support surface 108 while the middle mounting surface 106 is separated from the lower mounting surface 106 by a second wedge support surface 108. The two wedge support surfaces 108 provide points of attachment for a pair of auxiliary wedges 110. Each of the auxiliary wedges 110 has a width that generally corresponds to the width of the support surface 104 and the width of the supported wear plates 46. Each of the auxiliary wedges 110 include an outer face surface 112 and a mounting surface 114 spaced from the outer face surface 112 by the overall thickness of the auxiliary wedge 110. The width of the outer surface 112 is greater than the width of the mounting surface 114 such that each of the side walls 116 diverge outward from the mounting surface 114 to the outer face surface 112. As can be seen in FIGS. 5 and 8, the width of the auxiliary wedge 110 increases from the mounting surface 114 to the outer face surface 112 and has a shape that generally corresponds to the shape of the receiving slot 98 formed between the adjacent end surfaces of two of the wear plates 46 when mounted in the end-to-end relationship as shown.

Referring back to FIG. 7, each of the auxiliary wedges 110 includes a series of mounting openings 118 that are spaced and correspond to a similar series of mounting openings 117 formed in each of the wedge support surfaces 108. In this manner, a series of auxiliary clamping bolts can extend through both the auxiliary wedge 110 and the frame 70 to retain the auxiliary wedge 110 along one of the wedge support surfaces 108.

Referring back to FIG. 6, the auxiliary connecting bolts 119 used to secure the auxiliary wedge 110 to the frame 70 include a head portion 120 that is accessible from the back surface of the frame 70. Each of the head portions 120 of the auxiliary connecting bolts 119 can include a spring member such that the auxiliary clamping bolts 119 can slightly flex upon contact between the wear surface of the wear plate 46 and material during the crushing operation. Each of the auxiliary clamping bolts 119 can be removed from the outside of the frame 70 when replacement of the wear plates 46 is desired.

Referring back to FIG. 7, each of the mounting surfaces 106 includes a pair of keys 122 that interact with corresponding slots (not shown) formed in the flat engagement surface 84 on each of the wear plates 46 to correctly position each of the wear plates 46 along one of the mounting surfaces. The keys 122 are designed to both position the wear plate 46 and to prevent and restrict lateral movement of the wear plate 46 along the respective mounting surface 106 during operation of the crusher.

In the embodiment shown in FIGS. 5 and 8, the crusher jaw 20 includes an upper wear plate, a lower wear plate and a middle wear plate that are oriented adjacent to each other in an end-to-end relationship. When the wear plates 46 are mounted as shown, the second end surface 88 of the upper wear plate is positioned adjacent to the first end surface 86 of the middle wear plate 46. Likewise, the second end surface 88 of the middle wear plate 46 is positioned adjacent to the first end surface 86 of the lower wear plate 46. The spacing between the end surfaces of the adjacent wear plates 46 is selected to be as small as possible to prevent material from being trapped between these two end surfaces. However, a slight space between the wear plates 46 allows the wear plates 46 to move slightly during operation of the compact eccentric crusher.

As shown in FIGS. 5 and 8, the second end 74 of the crusher frame 70 includes an end stop 124 that is designed to engage and restrict the movement of the second end surface 88 of the lower wear plate 46. The end stop 124 is a single piece metallic component that includes a locking finger 126 that is received within a slot 128 formed in the frame 70 near the second end 74. The interaction between the locking finger 126 and the slot 128 prevents the movement of the end stop 124.

The opposite end of the end stop 124 includes a retaining finger 130 that extends inward from the outer wall 132 of the end stop 124. The shape of the retaining finger 130 generally corresponds to the shape of the retaining groove 90 formed in the second end surface 88 of the lower wear plate 46. As shown in FIG. 5, the interaction between the retaining finger 130 and the retaining groove 90 restricts the movement of the lower wear plate 46 past the second end 74 of the frame 70.

During the initial installation of the wear plates 46 on the frame 70, the lower wear plate 46 is initially installed and slid into place until the retaining finger 130 of the end stop 124 is received within the retaining groove 90 formed in the second end surface 88. Once the lower wear plate 46 is in place, the lower of the two auxiliary wedges 110 is slid into place and received within the retaining groove 90 formed in the first end 86 of the lower wear plate 46. Once the lower auxiliary wedge 110 is in place, the auxiliary clamping bolts 119 are used to attach the auxiliary wedge 110 to the lower wedge support surface 108. Once the lower auxiliary wedge 110 is in place, the middle wear plate 46 is installed and slid into place until the retaining groove 90 on the second end surface 88 contacts the lower auxiliary wedge 110. Once the middle wear plate 46 is in position, the upper auxiliary wedge 110 is installed and secured by the auxiliary clamping bolts 119.

After the lower wear plate 46 and middle wear plate 46 are installed, the upper wear plate 46 is slid into position until the retaining groove 90 formed on the second end surface 88 of the upper wear plate 46 contacts the upper auxiliary wedge 110. In this manner, the three wear plates 46 can be installed on the support surface 104 defined by the frame 70.

After the three wear plates are installed, a master wedge 134 is attached to the first end 72 of the frame 70 to lock the three wear plates 46 in position. As shown in FIGS. 5 and 8, the master wedge 134 is positioned above a locking block 136 that is configured to be received within the retaining groove 90 formed on the first end surface 86 of the upper wear plate 46. When the locking block 136 is in position, the master wedge 134 is secured to the frame 70 by a series of master clamping bolts that extend through openings 138 formed in the outer face 140 of the master wedge 134. As can be seen in the back view of FIG. 6, the master clamping bolts 142 are each accessible from the back of the frame 70. In this manner, the master clamping bolts 142 can be removed from the back of the frame 70 to release the attachment of the master wedge 134. As can be understood in FIGS. 5 and 8, the combination of the end stop 124 on the second end 74 and the master wedge 134 on the first end 72 lock the three wear plates 46 in position along the support surface 104 of the frame 70.

As can be seen in FIGS. 5 and 7, the first end of the frame 70 further includes an impact plate 144 mounted to a support block 146 located at the first end 72. The impact plate 144 is a wear element that can be removed and replaced upon wear. The impact plate 144 is positioned such that mineral material entering into the crushing chamber initially contacts the impact plate 144 and then is directed down toward the wear surface 82 on each of the wear plates 46.

In addition to aiding in the ease of the installation process of the individual wear plates 46, the system of the present disclosure also improves the removal and replacement of the wear plates 46 when needed. When the individual wear plates 46 need to be removed, the first step in the removal process is to remove the master wedge 134 by initially removing the master clamping bolts 142 shown in FIG. 6. Once the master clamping bolts 142 have been removed, the master wedge 134 and the associated locking block 136 can be removed from the frame 70.

With these members removed, the upper wear plate 46 can be removed from the frame 70. After the upper wear plate 46 has been removed, the upper auxiliary wedge 110 is exposed and the auxiliary clamping bolts 119 used to hold the upper auxiliary wedge 110 can be removed to release the upper auxiliary wedge 110. Once removed, the middle wear plate 46 can be lifted away from the frame 70, thus exposing the lower auxiliary wedge 110. The lower auxiliary wedge 110 can be released by removing the auxiliary clamping bolts 119. With the lower auxiliary wedge 110 removed, the lower wear plate 46 can be lifted away from the frame.

Once all three of the wear plates 46 have been removed, replacement wear plates can be installed in the manner as was previously described. As can be understood by the previous disclosure, the method and system of the present disclosure allows for fast mounting and dismounting of the individual wear plates 46 to the frame 70 of the crusher jaw 20. The pair of auxiliary wedges 110 and the master wedge 134 hold the individual wear plates in an end-to-end relationship along the support surface of the frame. The slight spacing between the end face surfaces of the individual wear plates 46 allow the wear plates 46 to flex and move slightly relative to each other to help reduce the wear and cracking of the individual wear plates. The individual keys formed on each of the mounting surfaces of the frame aid to prevent any axial movement of the wear plates 46 during operation.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A crusher for crushing a supply of mineral material, the crusher comprising:
a crusher frame having a pair of side walls that at least partially define a crushing chamber;
a crusher jaw that is positioned to at least partially define the crushing chamber;
a crushing roller spaced from the stationary crushing member by a crushing gap, wherein the crushing roller is movable toward and away from the stationary crushing member to change the crushing gap and crush the mineral material within the crushing gap;
wherein the crusher jaw comprises:
a frame having a support surface extending from a first end to a second end; and
a plurality of wear plates removably supported on the support surface in an end-to-end arrangement such that the plurality of wear plates define a wear surface of the crusher jaw when supported on the frame.

2. The crusher of claim 1 wherein each of the plurality of wear plates are identical.

3. The crusher of claim 1 wherein each of the wear plates include a first end surface and a second end surface that each include a retaining groove recessed from the first and second end surfaces.

4. The crusher of claim 1 further comprising at least one auxiliary wedge positioned between adjacent wear plates and mounted to the frame to restrict the movement of the wear plates along the support surface.

5. The crusher of claim 1 further comprising a plurality of keys each extending from the support surface and received within one of the wear plates to align the wear plates on the support surface and restrict lateral movement of the wear plate.

6. The crusher of claim 1 wherein the master wedge is positioned between one of the wear plates and a locking bar mounted to the first end of the frame.

7. The crusher of claim 3 further comprising an end stop positioned at the second end of the support surface to engage one of the plurality of wear plates, wherein the end stop includes a retaining finger that is received in the retaining groove on one of the first and second end surfaces of the wear plate positioned at the second end of the frame.

8. The crusher jaw of claim 1 wherein the support surface of the frame includes a plurality of flat mounting surfaces each configured to receive one of the wear plates.

9. The crusher of claim 8 wherein each of the wear plates includes a flat engagement surface and a curved wear surface, wherein the flat mounting surface is in contact with the support surface of the frame.

10. The crusher of claim 1 wherein the plurality of wear plates include an upper wear plate, a lower wear plate and a middle wear plate, wherein the lower wear plate is supported at one end by the end stop and the upper wear plate is engaged by the master wedge and a first auxiliary wedge is positioned between the upper wear plate and the middle wear plate and a second auxiliary wedge is positioned between the lower wear plate and the middle wear plate.

11. A crusher jaw for a compact eccentric crusher that includes a crushing roller that is movable toward and away from the crusher jaw to crush mineral material, the crusher jaw comprising:
a frame having a support surface extending from a first end to a second end;
a plurality of wear plates supported on the support surface, wherein the plurality of wear plates are positioned in an end-to-end arrangement and extend from the first end to the second end of the frame;
an end stop positioned at the second end of the support surface to engage one of the plurality of wear plates; and
a master wedge positioned at the first end of the support surface to engage another one of the plurality of wear plates.

12. The crusher jaw of claim 11 wherein each of the plurality of wear plates are identical.

13. The crusher jaw of claim 12 wherein each of the wear plates include a first end surface and a second end surface that each include a retaining groove recessed from the first and second end surfaces.

14. The crusher jaw of claim 11 further comprising at least one auxiliary wedge positioned between adjacent wear plates and mounted to the frame to restrict the movement of the wear plates along the support surface.

15. The crusher jaw of claim 11 further comprising at least one key extending from the support surface and received within each of the wear plates to align the wear plates on the support surface and restrict lateral movement of the wear plate.

16. The crusher jaw of claim 11 wherein the master wedge is positioned between one of the wear plates and a locking bar mounted to the first end of the frame.

17. The crusher jaw of claim 11 wherein the end stop includes a retaining finger that is received in the retaining groove on one of the first and second end surfaces of the wear plate positioned at the second end of the frame.

18. The crusher jaw of claim 11 wherein the support surface of the frame includes plurality of flat mounting surfaces each configured to receive one of the wear plates.

19. The crusher jaw of claim 18 wherein each of the wear plates includes a flat engagement surface and a curved wear surface, wherein the flat engagement surface is in contact with one of the mounting surfaces of the frame.

20. The crusher jaw of claim 11 wherein the plurality of wear plates include an upper wear plate, a lower wear plate and a middle wear plate, wherein the lower wear plate is supported at one end by the end stop and the upper wear plate is engaged by the master wedge and a first auxiliary wedge is positioned between the upper wear plate and the middle wear plate and a second auxiliary wedge is positioned between the lower wear plate and the middle wear plate.
